(19) United States
(12) Patent Application Publication
(10) Pub. No.: US 2025/0110309 A1
(43) Pub. Date: Apr. 3, 2025

(54) LENS DRIVING APPARATUS AND CAMERA MODULE

(71) Applicant: ALPS ALPINE CO., LTD., Tokyo (JP)

(72) Inventor: Changxing WANG, Miyagi (JP)

(21) Appl. No.: 18/891,294

(22) Filed: Sep. 20, 2024

(30) Foreign Application Priority Data
Sep. 28, 2023 (JP) 2023-168411

(51) Int. Cl. G02B 7/02; G02B 7/09; G03B 17/12; G03G 13/34

(52) U.S. Cl. CPC G02B 7/026; G02B 7/025; G02B 7/09; G03B 17/12; G03G 13/34

(57) ABSTRACT

A lens driving apparatus includes a fixed member, a lens holding member having a tubular part capable of holding a lens body adhered thereto with an adhesive, and an actuator configured to move the lens holding member with respect to the fixed member, wherein the lens holding member is formed of synthetic resin in which one or more metal adherends are embedded, wherein the metal adherends each have both an embedded part embedded in the tubular part and an exposed part exposed on an inner surface of the tubular part, and are configured such that the exposed part serves as a portion bonded and fixed to the lens body, and wherein at least one of the metal adherends is disposed at a position corresponding to a weld line formed when the lens holding member is molded.

### CROSS-REFERENCE TO RELATED APPLICATIONS

The present application is based on and claims priority to Japanese patent application No. 2023-168411 filed on Sep. 28, 2023, with the Japanese Patent Office, the entire contents of which are hereby incorporated by reference.

### BACKGROUND OF THE INVENTION

### 1. Field of the Invention

The disclosures herein relate to lens driving apparatuses and camera modules.

### 2. Description of the Related Art

Conventionally, a lens driving apparatus has been known in which a lens holder (lens holding member) to hold a lens part (lens body) is moved by a voice coil motor (see Patent Literature (PTL) 1). In this lens driving apparatus, the lens body is fixed to the lens holding member by adhesion or screwing.

### CITATION LIST

### Patent Literature

[PTL 1] International Publication No. WO 2017/175254

Generally, the lens holding member is formed of a synthetic resin. When the lens body is fixed to the lens holding member with an adhesive, if an adhesive area between the lens body and the lens holding member decreases as a height of the lens driving apparatus decreases, adhesive strength becomes insufficient, and the adhesive may be peeled off by an impact such as a drop. A risk of the adhesive peeling increases as a diameter of the lens body increases (a size of an imaging sensor increases).

Therefore, it is desirable to provide a lens driving apparatus capable of increasing the adhesive strength between the lens body and the lens holding member.

### SUMMARY OF THE INVENTION

A lens driving apparatus includes a fixed member, a lens holding member having a tubular part capable of holding a lens body adhered thereto with an adhesive, and an actuator configured to move the lens holding member with respect to the fixed member, wherein the lens holding member is formed of synthetic resin in which one or more metal adherends are embedded, wherein the metal adherends each have both an embedded part embedded in the tubular part and an exposed part exposed on an inner surface of the tubular part, and are configured such that the exposed part serves as a portion bonded and fixed to the lens body, and wherein at least one of the metal adherends is disposed at a position corresponding to a weld line formed when the lens holding member is molded.

The lens driving apparatus described above can increase the adhesive strength between the lens body and the lens holding member.

### BRIEF DESCRIPTION OF THE DRAWINGS

FIG. 1 is a perspective view of a camera module including a lens driving apparatus according to an embodiment of the present disclosure;

FIG. 2 is an exploded perspective view of the lens driving apparatus shown in FIG. 1;

FIG. 3 is a perspective view of a lens holding member, movable metal members, flat springs, first magnetic members, and metal adherends;

FIG. 4 is a perspective view of fixed metal members, the flat springs, a base member, and conductive members;

FIG. 5 is a drawing with two views: a right side view and a front view of metal members and shape memory alloy wires;

FIG. 6 is a perspective view of the metal members, the flat springs, the conductive members, the metal adherends, and the shape memory alloy wires;

FIG. 7 is a top view of the metal members, the flat springs, and the metal adherends;

FIG. 8 is a perspective view and a top view of the first magnetic members and the conductive members;

FIG. 9 is a perspective view and a cross-sectional view of a lens holding member with the metal adherends embedded therein;

FIG. 10 is a perspective view of a camera module including a lens driving apparatus according to another embodiment of the present disclosure;

FIG. 11 is an exploded perspective view of the lens driving apparatus shown in FIG. 10;

FIG. 12 is a perspective view of a lens holding member, a coil, and the metal adherends; and

FIG. 13 is one figure with four drawings: perspective views of a portion of a lens driving apparatus in which various metal adherends are embedded.

### DESCRIPTION OF THE PREFERRED EMBODIMENTS

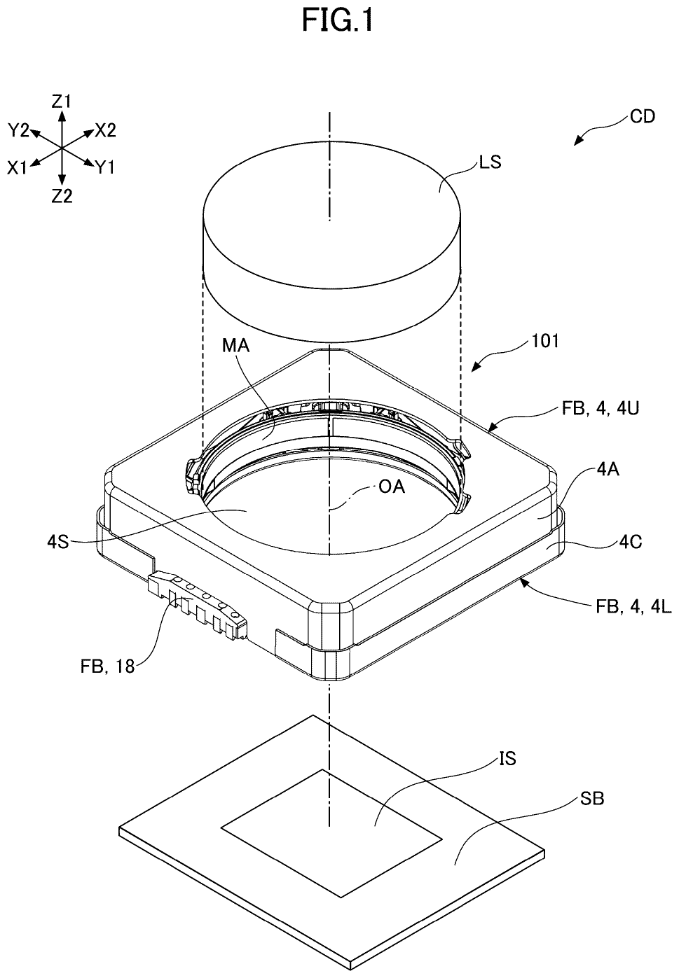

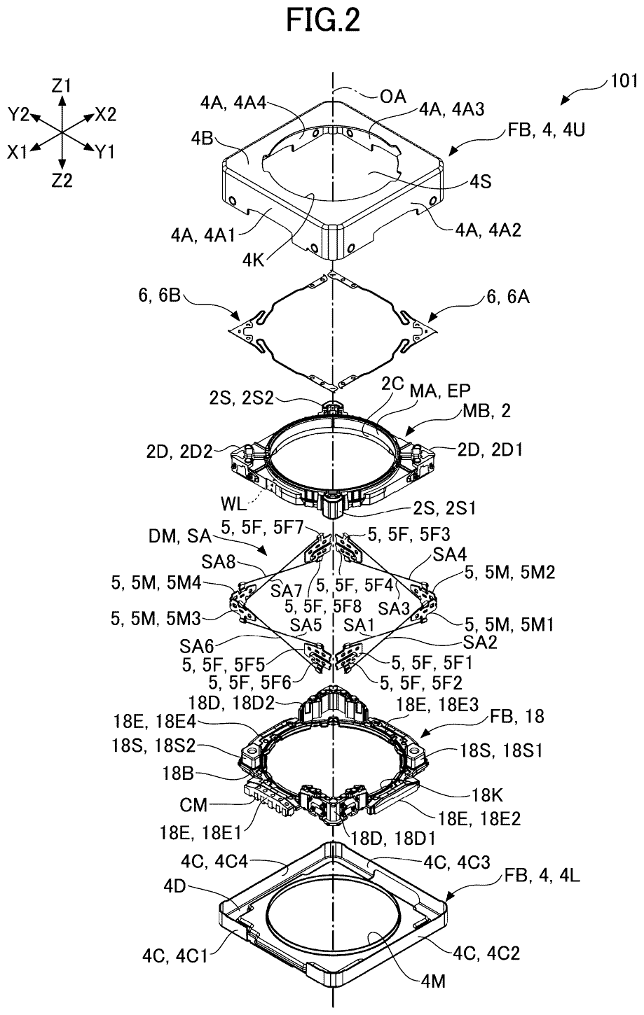

In the following, a lens driving apparatus 101 related to embodiments of the present invention will be described with reference to the accompanying drawings. FIG. 1 is a perspective view of a camera module CD including the lens driving apparatus 101. FIG. 2 is an exploded perspective view of the lens driving apparatus 101.

In FIGS. 1 and 2, X1 represents one direction of an X axis of a three-dimensional rectangular coordinate system, and X2 represents another direction of the X axis. Y1 represents one direction of a Y axis of the three-dimensional rectangular coordinate system, and Y2 represents another direction of the Y axis. Similarly, Z1 represents one direction of a Z axis of the three-dimensional rectangular coordinate system, and Z2 represents another direction of the Z axis. In FIGS. 1 and 2, the X1 direction of the lens driving apparatus 101 corresponds to a front (front face) of the lens driving apparatus 101, and the X2 direction of the lens driving apparatus 101 corresponds to a rear (rear face) of the lens driving apparatus 101. The Y1 direction of the lens driving apparatus 101 corresponds to a right face of the lens driving apparatus 101, and the Y2 direction of the lens driving apparatus 101 corresponds to a left face of the lens driving apparatus 101. The Z1 direction of the lens driving apparatus 101 corresponds to a top (facing a subject) of the lens driving apparatus 101, and the Z2 direction of the lens driving apparatus 101 corresponds to a bottom (facing an imaging sensor) of the lens driving apparatus 101. The same is true in other figures.

As shown in FIG. 1, the camera module CD includes a substrate SB, the lens driving apparatus 101, a lens body LS mounted on the lens driving apparatus 101, and the imaging sensor IS mounted on the substrate SB facing the lens body LS. In addition, the camera module CD is connected to a control device composed of such as a microcomputer including a CPU, a memory, and the like. In an illustrated example, the control device is disposed at an outer position relative to the camera module CD, but may be disposed at an inner position relative to the camera module CD. As shown in FIG. 1, the lens driving apparatus 101 having a substantially rectangular parallelepiped shape is mounted on the substrate SB on which the imaging sensor IS is mounted.

Specifically, as shown in FIG. 1 and FIG. 2, the lens driving apparatus 101 includes a cover member 4, which is a part of a fixed member FB. The cover member 4 includes an upper cover member 4U and a lower cover member 4L.

The cover member 4 is configured to function as a housing covering each member. In the present embodiment, the cover member 4 is formed of a nonmagnetic metal. However, the cover member 4 may be formed of a magnetic metal. As shown in FIG. 1, the cover member 4 has a box-shaped outer shape defining the housing 4S.

As shown in FIG. 2, the upper cover member 4U has a first outer peripheral wall 4A having a rectangular tubular shape and a top plate 4B having a rectangular annular shape and a flat plate shape, which is provided so as to be continuous with the upper end (end on the Z1 direction) of the first outer peripheral wall 4A. A circular opening 4K is formed in the center of the top plate 4B. The first outer peripheral wall 4A includes first lateral plates 4A1 to fourth lateral plates 4A4. The first lateral plate 4A1 and the third lateral plate 4A3 face each other, and the second lateral plate 4A2 and the fourth lateral plate 4A4 face each other. The first lateral plate 4A1 and the third lateral plate 4A3 extend perpendicularly to the second lateral plate 4A2 and the fourth lateral plate 4A4.

Similarly, as shown in FIG. 2, the lower cover member 4L has a rectangular tubular second outer peripheral wall 4C and a rectangular annular bottom plate 4D provided so as to continue to the lower end (end on the Z2 direction) of the second outer peripheral wall 4C. A circular opening 4M is formed in the center of the bottom plate 4D. The second outer peripheral wall 4C includes first lateral plates 4C1 to fourth lateral plates 4C4. The first lateral plate 4C1 and the third lateral plate 4C3 face each other, and the second lateral plate 402 and the fourth lateral plate 4C4 face each other. The first lateral plate 4C1 and the third lateral plate 4C3 extend perpendicular to the second lateral plate 4C2 and the fourth lateral plate 4C4.

The upper cover member 4U is joined to the lower cover member 4L by an adhesive as shown in FIG. 1. The second outer peripheral wall 4C is disposed to partially cover the first outer peripheral wall 4A.

As shown in FIG. 2, the cover member 4 contains a lens holding member 2, metal members 5, flat springs 6, a base member 18, shape memory alloy wires SA, and the like. The lens holding member 2 is a member capable of holding the lens body LS (see FIG. 1) and is included in a movable member MB. The lens body LS is, for example, a tubular lens barrel including at least one lens, and configured to have a central axis disposed along an optical axis OA.

The lens holding member 2 is formed by injection molding synthetic resin such as a liquid crystal polymer (LCP). Specifically, as shown in FIG. 2, the lens holding member 2 includes a tubular part 2C formed to extend along the optical axis OA, and movable pedestal parts 2D and protruding parts 2S formed so as to protrude from the tubular part 2C radially outward of a circle about the optical axis OA. The movable pedestal parts 2D and the protruding parts 2S are included in the tubular part 2C. In the present embodiment, one or more metal adherends MA are embedded in the lens holding member 2. An adhesive is applied between the lens body LS and the metal adherends MA, and the lens body LS is adhered and fixed to the metal adherends MA and the lens holding member 2 by the adhesive.

The movable pedestal parts 2D include a first movable pedestal part 2D1 and a second movable pedestal part 2D2. The first movable pedestal part 2D1 and the second movable pedestal part 2D2 are disposed so as to extend in opposite directions in the radial direction across the optical axis OA. Similarly, the protruding parts 2S include a first protruding part 21 and a second protruding part 2S2. The first protruding part 2S1 and the second protruding part 2S2 are disposed so as to extend in opposite directions in the radial direction across the optical axis OA. Specifically, the movable pedestal parts 2D and the protruding parts 2S are disposed so as to correspond to four corners of the lens holding member 2 having a substantially rectangular outer shape in a top view, and are disposed so as to be alternately disposed. A part of each of the flat springs 6 is placed on a corresponding movable pedestal part 2D of the two movable pedestal parts 2D.

An actuator DM is a mechanism to move the lens holding member 2 with respect to the fixed member FB. In the present embodiment, the actuator DM includes shape memory alloy wires SA as an example of a shape memory actuator. Specifically, the shape memory alloy wires SA include a first wire SA1 to an eighth wire SA8. The temperature of the shape memory alloy wires SA rises when an electric current flows, and the shape memory alloy wires SA contract in accordance with the rise in temperature. The actuator DM can move the lens holding member 2 up and down at least along the optical axis OA by utilizing the contraction of the shape memory alloy wires SA. The shape memory alloy wires SA are configured such that when one or more of the first wire SA1 to the eighth wire SA8 contract, the lens holding member 2 moves, and the other one or more wires are stretched by the movement.

The flat springs 6 are configured to be able to movably support the lens holding member 2 in a direction parallel to the optical axis OA with respect to the fixed member FB (base member 18). In the present embodiment, the flat springs 6 are made of metal plates mainly made of, for example, a copper alloy, a titanium-copper alloy (titanium-copper), or a copper-nickel alloy (nickel-tin-copper). Specifically, the flat springs 6 include a first flat spring 6A and a second flat spring 6B.

The base member 18 is formed by injection molding using a synthetic resin such as a liquid crystal polymer (LCP). In the present embodiment, the base member 18 has a substantially rectangular outer shape in top view and has a circular opening 18K in the center. Specifically, the base member 18 has a rectangular annular base part 18B disposed so as to surround the circular opening 18K. The base part 18B has four edges 18E (a first edge 18E1 to a fourth edge 18E4).

The flat springs 6 are configured to connect movable pedestal parts 2D formed in the lens holding member 2 and fixed pedestal parts 18D formed in the base member 18. The fixed pedestal parts 18D are portions protruding upward from the base part 18B of the base member 18 and include a first fixed pedestal part 18D1 and a second fixed pedestal part 18D2.

More specifically, the first flat spring 6A is configured to connect the first movable pedestal part 2D1 formed on the lens holding member 2 to the first fixed pedestal part 18D1 and the second fixed pedestal part 18D2 formed on the base member 18. Similarly, the second flat spring 6B is configured to connect the second movable pedestal part 2D2 formed on the lens holding member 2 to the first fixed pedestal part 18D1 and the second fixed pedestal part 18D2 formed on the base member 18.

Each of the metal members 5 is configured so that the end portion of the shape memory alloy wire SA is fixed respectively. In the present embodiment, the metal members 5 are formed of a nonmagnetic metal and include fixed metal members 5F and movable metal members 5M. The fixed metal members 5F are configured so as to be fixed to the fixed pedestal parts 18D of the base member 18. The movable metal members 5M are configured so as to be fixed to the movable pedestal parts 2D of the lens holding member 2. The fixed metal members 5F may be embedded in the fixed pedestal part 18D of the base member 18, and the movable metal members 5M may be embedded in the movable pedestal part 2D of the lens holding member 2.

More specifically, the fixed metal members 5F are also referred to as fixed terminal plates and include a first fixed metal member 5F1 to an eighth fixed metal member 5F8. The movable metal members 5M are also referred to as movable terminal plates and include a first movable metal member 5M1 to a fourth movable metal member 5M4.

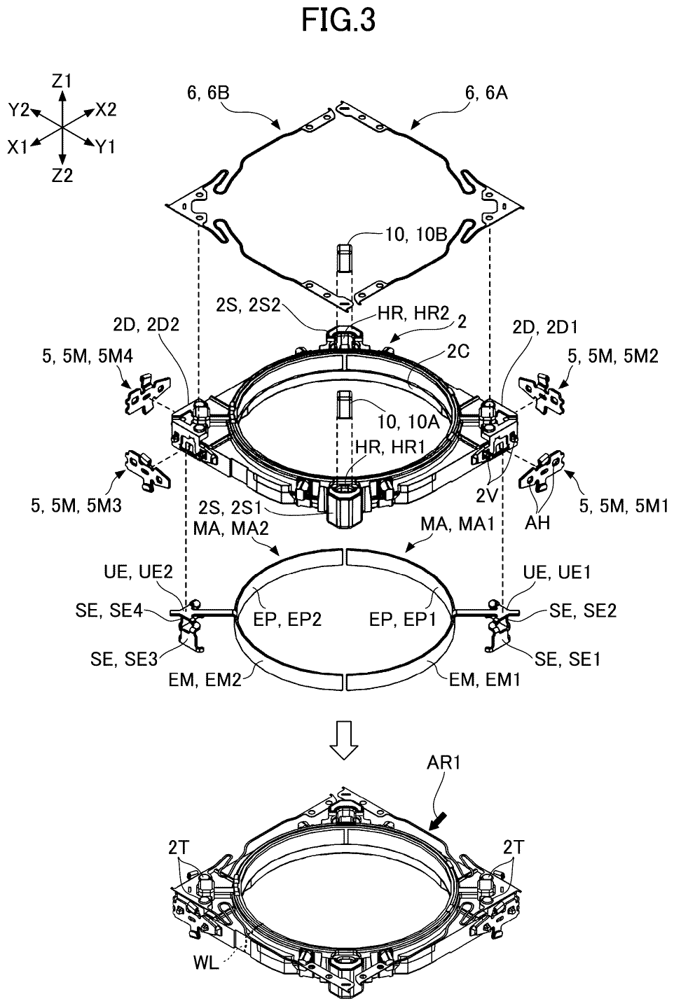

Next, with reference to FIG. 3, the positional relation between the members provided in the lens holding member 2 and the lens holding member 2 will be described. FIG. 3 is a perspective view of the lens holding member 2, the movable metal members 5M, the flat springs 6, the first magnetic members 10, and the metal adherends MA. Specifically, the upper view of FIG. 3 (above the block arrows) is an exploded perspective view of the lens holding member 2, the movable metal members 5M, the flat springs 6, the first magnetic members 10, and the metal adherends MA, and the lower view of FIG. 3 (below the block arrows) is an assembled perspective view of the lens holding member 2, the movable metal members 5M, the flat springs 6, the first magnetic members 10, and the metal adherends MA. In the lower view of FIG. 3, the position corresponding to the gate (entrance for pouring the synthetic resin into the mold) at the time of injection molding of the lens holding member 2 is at the center on the rear (X2 direction) of the tubular part 2C of the lens holding member 2, which is represented by a black block arrow AR1, and the weld line WL formed during injection molding is at the center on the front (X1 direction) of the tubular part 2C, which is represented by a thick dotted line. The weld line WL is a linear trace left at a portion where the molten resin flowing through two different paths in the mold in injection molding merges.

In the example shown in the upper view of FIG. 3, the first movable metal member 5M1 is fixed to the outer surface (right mounting surface) of the lateral wall on the Y1 direction of the first movable pedestal part 2D1. Specifically, the first movable metal member 5M1 is fixed to the first movable pedestal part 201 by an adhesive in a state where two rectangular protrusions 2V formed on the first movable pedestal part 2D1 and protruding outward (in the Y1 direction) are engaged with two rectangular holes AH formed on the first movable metal member 5M1. The adhesive is, for example, a light-curing adhesive. The light-curing adhesive is, for example, an ultraviolet curing adhesive or a visible light curing adhesive. Similarly, the second movable metal member 5M2 is fixed to the outer surface (rear mounting surface) of the X2 direction lateral wall of the first movable pedestal part 201, the third movable metal member 5M3 is fixed to the outer surface (front mounting surface) of the X1 direction lateral wall of the second movable pedestal part 2D2, and the fourth movable metal member 5M4 is fixed to the outer surface (left mounting surface) of the Y2 direction lateral wall of the second movable pedestal part 2D2.

Each of the metal adherends MA is disposed in the lens holding member 2 such that a portion thereof is embedded in the lens holding member 2 and the remaining portion thereof is exposed from the lens holding member 2. In the illustrated example, each of the metal adherends MA is partially embedded in the lens holding member 2 by insert molding. Each of the metal adherends MA has an embedded part EM embedded in the tubular part 2C and an exposed part EP exposed to the inner surface of the tubular part 2C, and the exposed part EP is configured to be a portion bonded and fixed to the lens body LS. Each of the metal adherends MA has an upper exposed part UE exposed to the upper surface of the movable pedestal part 2D and an outer exposed part SE exposed to the outer surface of the movable pedestal part 2D, and the upper exposed part UE is configured to be a portion joined to the corresponding flat spring 6, and the outer exposed part SE is configured to be a portion joined to the corresponding movable metal member 5M.

Specifically, the metal adherends MA include a first metal adherend MA1 and a second metal adherend MA2. The first metal adherend MA1 has a first embedded part EM1, a first exposed part EP1, a first upper exposed part UE1, a first outer exposed part SE1, and a second outer exposed part SE2, and the second metal adherend MA2 has a second embedded part EM2, a second exposed part EP2, a second upper exposed part UE2, a third outer exposed part SE3, and a fourth outer exposed part SE4. The lens body LS is adhered and fixed to the first exposed part EP1 and the second exposed part EP2, the first flat spring 6A is welded to the first upper exposed part UE1, and the second flat spring 6B is welded to the second upper exposed part UE2. The first movable metal member 5M1 is welded to the first outer exposed part SE1, the second movable metal member 5M2 is welded to the second outer exposed part SE2, the third movable metal member 5M3 is welded to the third outer exposed part SE3, and the fourth movable metal member 5M4 is welded to the fourth outer exposed part SE4. Therefore, the adhesive for fixing the movable metal members 5M to the movable pedestal parts 2D can be omitted.

In the illustrated example, a first metal adherend MA1 and a second metal adherend MA2 have the same shape and the same size. Specifically, the first metal adherend MA1 and the second metal adherend MA2 are configured to have two-fold rotational symmetry with respect to the optical axis OA. Therefore, this configuration can reduce the number of components of the lens driving apparatus 101.

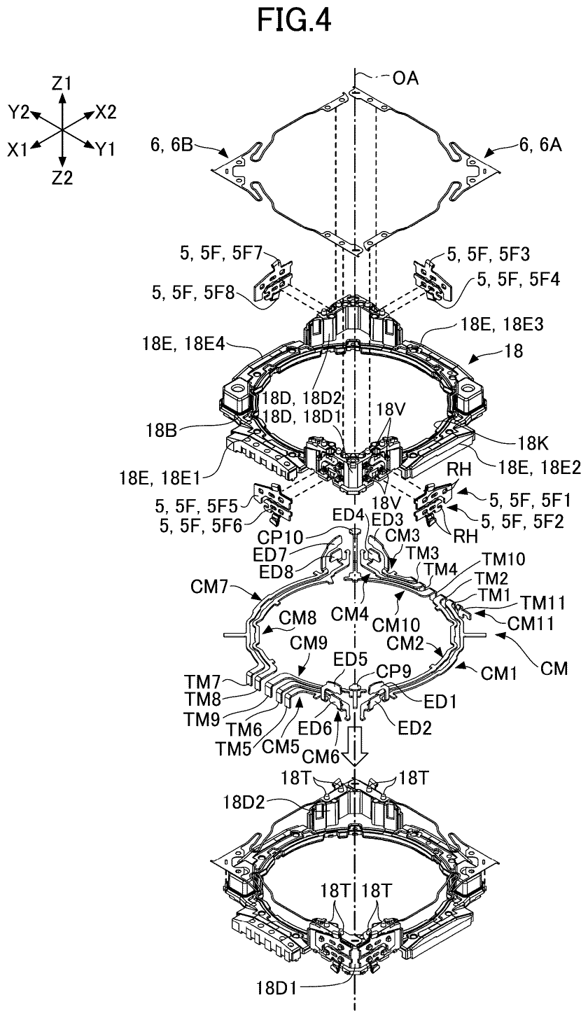

Next, with reference to FIG. 4, a positional relation between members provided on the base member 18 and the base member 18 will be described. FIG. 4 is a perspective view of fixed metal members 5F, the flat springs 6, the base member 18, and the conductive members CM. Specifically, the upper view of FIG. 4 (the view above the block arrow) is an exploded perspective view of the fixed metal members 5F, the flat springs 6, the base member 18, and the conductive members CM, and the lower view of FIG. 4 (the view below the block arrow) is an assembled perspective view of the fixed metal members 5F, the flat springs 6, the base member 18, and the conductive members CM.

In the example shown in the upper view of FIG. 4, the first fixed metal member 5F1 and the second fixed metal member 5F2 are fixed to the outer surface (right mounting surface) of the lateral wall on the Y1 direction of the first fixed pedestal part 18D1 disposed along the second edge 18E2 of the base member 18. Specifically, the first fixed metal member 5F1 and the second fixed metal member 5F2 are fixed to the first fixed pedestal part 18D1 by an adhesive in a state where the two rectangular protrusions 18V formed on the first fixed pedestal part 18D1 and protruding outward (in the Y1 direction) are engaged with the two penetrating parts RH formed on the first fixed metal member 5F1 and the second fixed metal member 5F2, respectively. The adhesive is, for example, a light-curing adhesive. The light-curing adhesive is, for example, an ultraviolet curing adhesive or a visible light-curing adhesive. Similarly, the third fixed metal member 5F3 and the fourth fixed metal member 5F4 are fixed to the outer surface (rear mounting surface) of the lateral wall in the X2 direction of the second fixed pedestal part 18D2 disposed along the third edge 18E3 of the base member 18. The fifth fixed metal member 5F5 and the sixth fixed metal member 5F6 are fixed to the outer surface (front mounting surface) of the X1 lateral wall of the first fixed pedestal part 18D1 disposed along the first edge 18E1 of the base member 18. The seventh fixed metal member 5F7 and the eighth fixed metal member 5F8 are fixed to the outer surface (left mounting surface) of the Y2 lateral wall of the second fixed pedestal part 18D2 disposed along the fourth edge 18E4 of the base member 18.

As shown in FIG. 2, the shape memory alloy wires SA extend along the inner surface of the first outer peripheral wall 4A of the upper cover member 4U when a current is supplied, and are configured to movably support the movable member MB relative to the fixed member FB. In the present embodiment, the shape memory alloy wires SA include a first wire SA1 to an eighth wire SA8, and are configured to movably support the lens holding member 2 as the movable member MB relative to the base member 18 as the fixed member FB. As shown in FIG. 2, one end of each of the first wire SA1 to eighth wire SA8 is fixed to the movable metal member 5M respectively by crimping or welding, and the other end is fixed to the fixed metal member 5F respectively by crimping or welding.

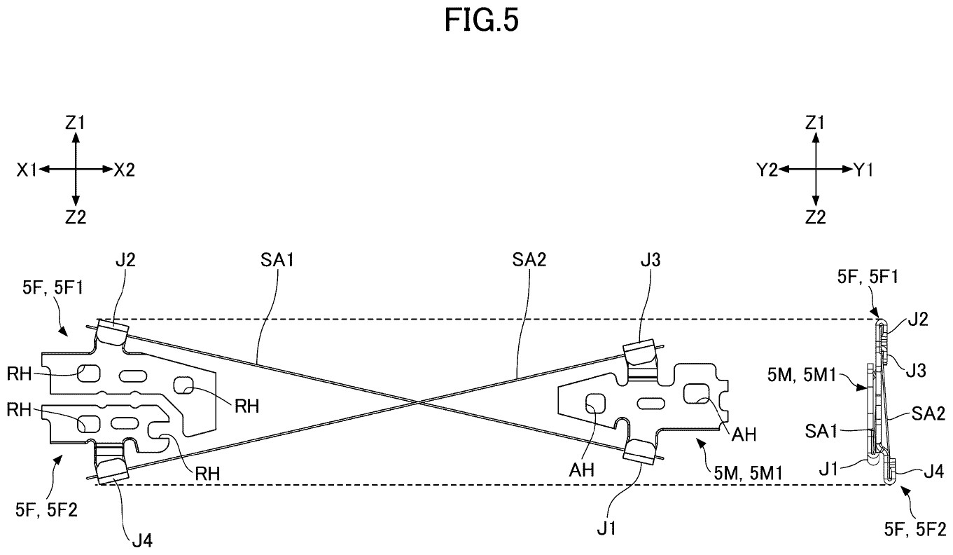

Next, the metal members 5 to which the shape memory alloy wires SA are attached will be described with reference to FIG. 5. FIG. 5 is a drawing with two views: an example of a configuration of the metal members 5 and the shape memory alloy wires SA. Specifically, the left drawing of FIG. 5 is a drawing (right side view) of the first wire SA1 attached to each of the first movable metal member 5M1 and the first fixed metal member 5F1, and the second wire SA2 attached to each of the first movable metal member 5M1 and the second fixed metal member 5F2 when viewed from the Y1 direction. The right drawing of FIG. 5 is a drawing (front view) of the first wire SA1 attached to the first movable metal member 5M1 and the first fixed metal member 5F1, and the second wire SA2 attached to the first movable metal member 5M1 and the second fixed metal member 5F2 when viewed from the X1 direction. The positional relation of the respective members shown in the left view of FIG. 5 and the right view of FIG. 5 corresponds to the positional relation when the lens driving apparatus 101 is assembled and electric current is supplied to the first wire SA1 and the second wire SA2. In the left view of FIG. 5 and the right view of FIG. 5, other members are omitted for clarity. Also, while the following description, referring to the left view of FIG. 5 and the right view of FIGS. 5, relates to the combination of the first wire SA1 and the second wire SA2, it may equally apply to the combination of the third wire SA3 and the fourth wire SA4, the combination of the fifth wire SA5 and the sixth wire SA6, and the combination of the seventh wire SA7 and the eighth wire SA8.

Specifically, one end of the first wire SA1 is fixed to the first movable metal member 5M1 at a holding part J1 on the bottom of the first movable metal member 5M1, and the other end of the first wire SA1 is fixed to the first fixed metal member 5F1 at a holding part J2 of the first fixed metal member 5F1. Similarly, one end of the second wire SA2 is fixed to the first movable metal member 5M1 at a holding part J3 on the top of the first movable metal member 5M1, and the other end of the second wire SA2 is fixed to the second fixed metal member 5F2 at a holding part J4 of the second fixed metal member 5F2.

The holding part J1 is formed by bending a part of the first movable metal member 5M1. Specifically, a part of the first movable metal member 5M1 is bent with one end of the first wire SA1 interposed therebetween to form the holding part J1. One end of the first wire SA1 is fixed to the holding part J1 by welding. The same applies to the holding parts J2 to J4.

As shown in FIG. 5, the first wire SA1 and the second wire SA2 are disposed so as to be skewed with respect to each other. That is, the first wire SA1 and the second wire SA2 are disposed so as not to be in contact (to be non-contact) with each other.

The base member 18 is configured to function as a wire support member for supporting the other ends of the first wire SA1 to the eighth wire SA8. With this configuration, the movable member MB is supported by the first wire SA1 to the eighth wire SA8 so as to be movable in the optical axis direction (Z axis direction), which is a direction parallel to the optical axis OA.

As shown in the upper view of FIG. 4, a fixed pedestal parts 18D are formed on the upper surface of the base member 18, which is a surface facing the subject (surface facing the Z1 direction). The fixed pedestal parts 18D include a first fixed pedestal part 18D1 and a second fixed pedestal part 18D2. The first fixed pedestal part 18D1 and the second fixed pedestal part 18D2 are disposed to face each other in the radial direction with the optical axis OA therebetween.

Conductive members CM as shown in the upper view of FIG. 4 are embedded in the base member 18 by insert molding. In the present embodiment, the conductive members CM are formed of a magnetic metal such as iron. The conductive members CM are configured to have a first terminal part TM1 to an eleventh terminal part TM11 that protrude from the lower surface (surface facing the Z2 direction) of the base member 18 and extend downward (Z2 direction), a first connecting part ED1 to an eighth connecting part ED8 that are exposed on the lateral surface of the base member 18, and a ninth joint surface CP9 and a tenth joint surface CP10 that are exposed on the upper surface of the base member 18.

Specifically, the conductive members CM include a first conductive member CM1 to an eleventh conductive member CM11. The first conductive member CM1 includes a first terminal part TM1 and a first connecting part ED1. The second conductive member CM2 includes a second terminal part TM2 and a second connecting part ED2. The third conductive member CM3 includes a third terminal part TM3 and a third connecting part ED3. The fourth conductive member CM4 includes a fourth terminal part TM4 and a fourth connecting part ED4. The fifth conductive member CM5 includes a fifth terminal part TM5 and a fifth connecting part ED5. The sixth conductive member CM6 includes a sixth terminal part TM6 and a sixth connecting part ED6. The seventh conductive member CM7 includes a seventh terminal part TM7 and a seventh connecting part ED7. The eighth conductive member CM8 includes an eighth terminal part TM8 and an eighth connecting part ED8. The ninth conductive member CM9 includes a ninth terminal part TM9 and a ninth joint surface CP9. The tenth conductive member CM10 includes a tenth terminal part TM10 and a tenth joint surface CP10. The eleventh conductive member CM11 includes an eleventh terminal part TM11.

The first terminal part TM1 to the fourth terminal part TM4, the tenth terminal part TM10, and the eleventh terminal part TM11 are disposed along the third edge 18E3 of the base member 18. The fifth terminal part TM5 to the ninth terminal part TM9 are disposed along the first edge 18E1 of the base member 18. Thus, the first terminal part TM1 to the eleventh terminal part TM11 are disposed along the first edge 18E1 or the third edge 18E3 of the base member 18, and are not disposed along the second edge 18E2 and the fourth edge 18E4 of the base member 18.

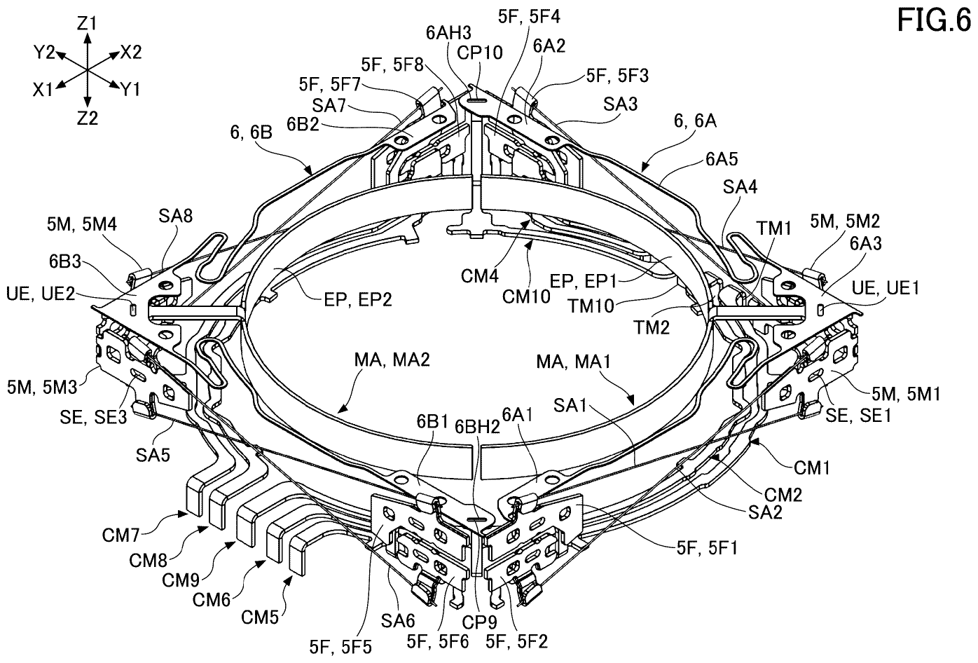

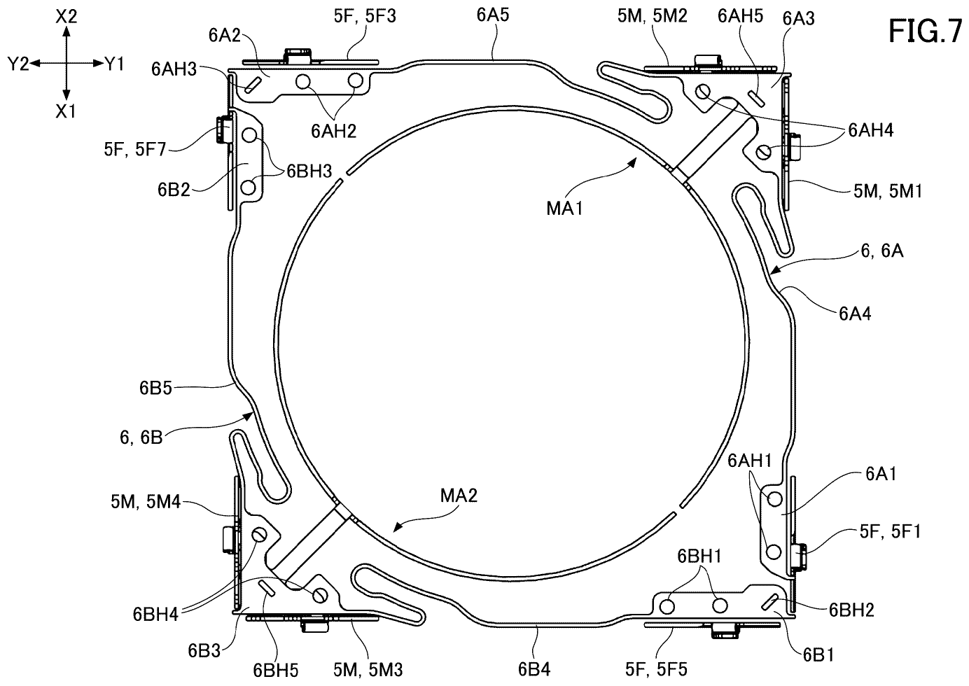

Next, the positional relation of the metal members 5, the flat springs 6, the conductive members CM, the metal adherends MA, and the shape memory alloy wires SA are described with reference to FIGS. 6 and 7. FIG. 6 is a perspective view of the metal members 5, the flat springs 6, the conductive members CM, the metal adherends MA, and the shape memory alloy wires SA. FIG. 7 is a top view of the metal members 5, the flat springs 6, and the metal adherends MA.

As shown in FIG. 7, the flat springs 6 include a first flat spring 6A and a second flat spring 6B. The first flat spring 6A has a first portion 6A1 fixed to the first fixed pedestal part 18D1 (see FIG. 2) of the base member 18, a second portion 6A2 fixed to the second fixed pedestal part 18D2 (see FIG. 2) of the base member 18, a third portion 6A3 fixed to the first movable pedestal part 2D1 (see FIG. 2) of the lens holding member 2, a fourth portion 6A4 connecting the first portion 6A1 and the third portion 6A3, and a fifth portion 6A5 connecting the second portion 6A2 and the third portion 6A3.

The first portion 6A1 is formed with two first through-holes 6AH1 through which two upwardly protruding circular protrusions 18T (see the lower drawing in FIG. 4) formed on the first fixed pedestal part 18D1 are inserted. In the present embodiment, the fixing between each of the flat springs 6 and the protrusions 18T is realized by performing thermal caulking or cold caulking on the protrusions 18T. However, the fixing between each of the flat springs 6 and the protrusions 18T may be realized respectively by an adhesive.

The second portion 6A2 is formed with two second through-holes 6AH2 through which two upwardly protruding circular protrusions 18T (see the lower drawing in FIG. 4) formed on the second fixed pedestal part 18D2 are inserted, and a third through-hole 6AH3 used for joining the tenth joint surface CP10 (see the upper drawing in FIG. 4) of the tenth conductive member CM10. In the present embodiment, the joining between each of the flat springs 6 and the conductive members CM respectively is realized by welding such as laser welding. However, the joining between each of the flat springs 6 and the conductive members CM respectively may be realized by solder or a conductive adhesive.

The third portion 6A3 is formed with two fourth through-holes 6AH4 through which two upwardly protruding circular protrusions 2T (see the upper drawing in FIG. 3) formed on the first movable pedestal part 2D1 are inserted. In the present embodiment, each of the flat springs 6 and the protrusions 2T are fixed by performing thermal caulking or cold caulking on the protrusion 2T. However, each of the flat springs 6 and the protrusions 2T may be fixed by an adhesive. In the third portion 6A3, a fifth through hole 6AH5 used for joining the first upper exposed part UE1 (see the upper drawing in FIG. 3) of the first metal adherend MA1 is formed. In the present embodiment, each of the flat springs 6 and the metal adherends MA are joined respectively by welding such as laser welding. However, each of the flat springs 6 and the metal adherends MA may be joined respectively by solder or a conductive adhesive.

Similarly, the second flat spring 6B has a first portion 6B1 fixed to the first fixed pedestal part 18D1 (see FIG. 2) of the base member 18, a second portion 6B2 fixed to the second fixed pedestal part 18D2 (see FIG. 2) of the base member 18, a third portion 6B3 fixed to the second movable pedestal part 2D2 (see FIG. 2) of the lens holding member 2, a fourth portion 6B4 connecting the first portion 6B1 and the third portion 6B3, and a fifth portion 6B5 connecting the second portion 6B2 and the third portion 6B3.

The first portion 6B1 is formed with two first through-holes 6BH1 through which two upwardly projecting circular protrusions 18T (see the drawing in FIG. 4) formed on the first fixed pedestal part 18D1 are inserted, and a second through-hole 6BH2 used for joining the ninth joint surface CP9 (see the drawing in FIG. 4) of the ninth conductive member CM9.

The second portion 6B2 is formed with two third through-holes 6BH3 through which two upwardly protruding circular protrusions 18T (see the lower drawing in FIG. 4) formed on the second fixed pedestal part 18D2 are inserted.

The third portion 6B3 is formed with two fourth through-holes 6BH4 through which two upwardly protruding circular protrusions 2T (see the lower drawing in FIG. 3) formed on the second movable pedestal part 2D2 are inserted. The third portion 6B3 is formed with a fifth through-hole 6BH5 used for joining the second upper exposed part UE2 (see the upper drawing in FIG. 3) of the second metal adherend MA2.

The fourth portion 6A4 and the fifth portion 6A5 of the first flat spring 6A and the fourth portion 6B4 and the fifth portion 6B5 of the second flat spring 6B are elastically deformable arms having a plurality of curved parts. Therefore, the lens holding member 2 is movable with respect to the base member 18 (fixed member FB) not only in a direction parallel to the optical axis OA but also in a direction intersecting the optical axis OA.

As shown in FIG. 7, the first flat spring 6A and the second flat spring 6B have the same shape and the same size. Specifically, the first flat spring 6A and the second flat spring 6B are configured to have a two-fold rotational symmetry with respect to the optical axis OA. Therefore, this configuration can reduce the number of components of the lens driving apparatus 101. The first flat spring 6A and the second flat spring 6B can support the lens holding member 2 in the air with good balance. Also, the flat springs 6 do not adversely affect the weight balance of the movable member MB supported by the eight shape memory alloy wires SA (first wire SA1 to eighth wire SA8).

As shown in FIG. 4, the first connecting part ED1 of the first conductive member CM1 is joined to the first fixed metal member 5F1 by welding. That is, the first connecting part ED1 and the first fixed metal member 5F1 are joined in a state where their surfaces are substantially parallel to each other. Similarly, the second connecting part ED2 of the second conductive member CM2 is joined to the second fixed metal member 5F2 by welding, the third connecting part ED3 of the third conductive member CM3 is joined to the third fixed metal member 5F3 by welding, and the fourth connecting part ED4 of the fourth conductive member CM4 is joined to the fourth fixed metal member 5F4 by welding. The fifth connecting part ED5 of the fifth conductive member CM5 is joined to the fifth fixed metal member 5F5 by welding, the sixth connecting part ED6 of the sixth conductive member CM6 is joined to the sixth fixed metal member 5F6 by welding, the seventh connecting part ED7 of the seventh conductive member CM7 is joined to the seventh fixed metal member 5F7 by welding, and the eighth connecting part ED8 of the eighth conductive member CM8 is joined to the eighth fixed metal member 5F8 by welding.

As shown in FIG. 3, the first movable metal member 5M1 is joined to the outer exposed part SE (first outer exposed part SE1) of the first metal adherend MA1 by welding. That is, the first movable metal member 5M1 and the outer exposed part SE (the first outer exposed part SE1) are joined in such a state that their surfaces are substantially parallel to each other. Similarly, the second movable metal member 5M2 is joined to the outer exposed part SE (the second outer exposed part SE2) of the first metal adherend MA1 by welding, the third movable metal member 5M3 is joined to the outer exposed part SE (the third outer exposed part SE3) of the second metal adherend MA2 by welding, and the fourth movable metal member 5M4 is joined to the outer exposed part SE (the fourth outer exposed part SE4) of the second metal adherend MA2 by welding.

Further, as shown in FIG. 7, the first fixed metal member 5F1 is spaced from the first portion 6A1 of the first flat spring 6A and is not in contact with the first portion 6A1 of the first flat spring 6A. Similarly, the third fixed metal member 5F3 is not in contact with the second portion 6A2 of the first flat spring 6A, the fifth fixed metal member 5F5 is not in contact with the first portion 6B1 of the second flat spring 6B, and the seventh fixed metal member 5F7 is not in contact with the second portion 6B2 of the second flat spring 6B.

As shown in FIG. 6, the ninth joint surface CP9 (see the upper drawing of FIG. 4) of the ninth conductive member CM9 is joined in parallel to the first portion 6B1 of the second flat spring 6B by welding such as laser welding at the second through hole 6BH2 formed in the first portion 6B1 of the second flat spring 6B. That is, the ninth joint surface CP9 and the first portion 6B1 are joined in a state where their surfaces are substantially parallel to each other. Similarly, the tenth joint surface CP10 (see the upper drawing of FIG. 4) of the tenth conductive member CM10 is joined in parallel to the second portion 6A2 of the first flat spring 6A by welding such as laser welding at the third through-hole 6AH3 formed in the second portion 6A2 of the first flat spring 6A as shown in FIG. 6.

As shown in FIG. 6, when the first terminal part TM1 of the first conductive member CM1 is connected to a high potential and the tenth terminal part TM10 of the tenth conductive member CM10 is connected to a low potential, the current flows from the first terminal part TM1 to the first fixed metal member 5F1 through the first conductive member CM1. The current then flows through the first fixed metal member 5F1, the first wire SA1, and the first movable metal member 5M1. The current then flows through the first metal adherend MA1 (the first outer exposed part SE1 and the first upper exposed part UE1), the third portion 6A3, the fifth portion 6A5, and the second portion 6A2 of the first flat spring 6A, and the tenth terminal part TM10 through the tenth conductive member CM10.

When the second terminal part TM2 of the second conductive member CM2 is connected to a high potential and the tenth terminal part TM10 of the tenth conductive member CM10 is connected to a low potential, the current flows through the second conductive member CM2 from the second terminal part TM2 to the second fixed metal member 5F2. The current then flows through the second fixed metal member 5F2, the second wire SA2, and the first movable metal member 5M1. The current then flows through the first metal adherend MA1 (the first outer exposed part SE1 and the first upper exposed part UE1), the third portion 6A3, the fifth portion 6A5, and the second portion 6A2 of the first flat spring 6A, and the tenth terminal part TM10 through the tenth conductive member CM10.

Whether the first terminal part TM1 of the first conductive member CM1 is connected to a high potential or the second terminal part TM2 of the second conductive member CM2 is connected to a high potential, the path of the current flowing from the first movable metal member 5M1 to the tenth terminal part TM10 is the same.

By controlling voltages applied to the respective terminals of the first conductive member CM1 to the tenth conductive member CM10, the control device located at an outer position relative to the lens driving apparatus 101 as described above can control the contraction of the first wire SA1 to the eighth wire SA8. The control device may be disposed within the lens driving apparatus 101. The control device may also be a component of the lens driving apparatus 101.

For example, the control device may move the lens holding member 2 along the direction parallel to the optical axis OA in the Z1 direction (facing subject) of the imaging sensor by utilizing the driving force parallel to the optical axis OA generated by the contraction of the shape memory alloy wire SA as the actuator DM. By moving the lens holding member 2 in this manner, the control device may realize an automatic focus adjustment function, which is one of the lens adjustment functions. Specifically, the control device may move the lens holding member 2 in the direction away from the imaging sensor to enable macro photography, and may move the lens holding member 2 in the direction toward the imaging sensor to enable infinity photography.

The control device may also move the lens holding member 2 in the direction intersecting the optical axis OA by controlling currents flowing through the plurality of shape memory alloy wires SA. Thus, the control device may realize a camera shake correction function.

As shown in the upper drawing of FIG. 3, the protruding parts 2S of the lens holding member 2 are formed with housing parts HR opening upward (in the Z1 direction). First magnetic members 10 are contained in the housing parts HR and fixed by an adhesive. Specifically, a first housing part HR1 opening upward is formed in the first protruding part 2S1, and a second housing part HR2 opening upward is formed in the second protruding part 2S2. A first magnet 10A is contained in the first housing part HR1, and a second magnet 10B is contained in the second housing part HR2.

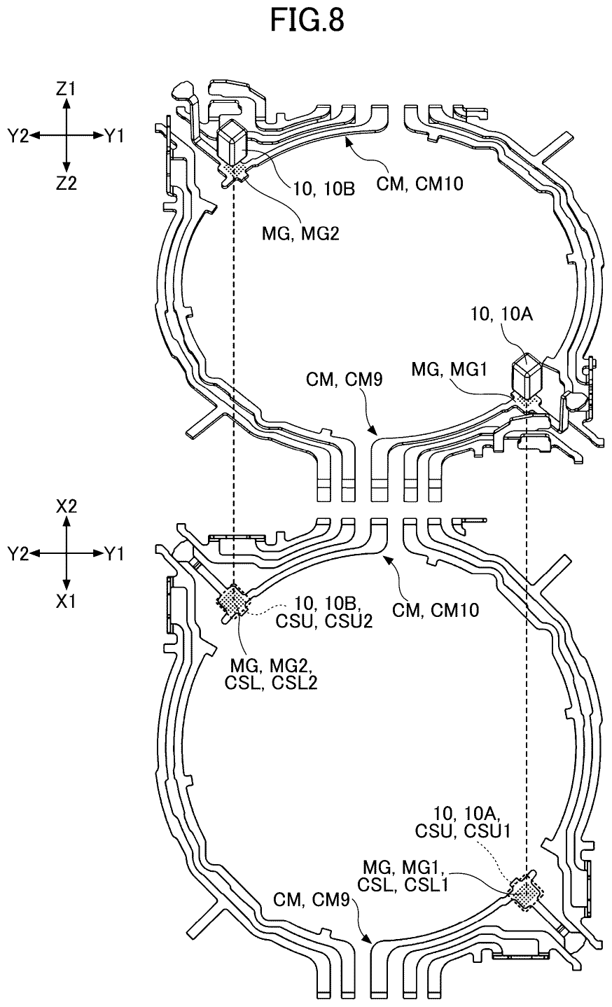

The first magnetic members 10 are members to generate a magnetic attraction force with the second magnetic members MG (see FIG. 8) attached to the base member 18. In the illustrated example, the first magnetic members 10 include a first magnet 10A and a second magnet 10B. Both the first magnet 10A and the second magnet 10B are bipolar permanent magnets. However, the first magnetic members 10 are not required to be magnets as long as they can generate a magnetic attraction force with the second magnetic members MG. In this case, the first magnetic members 10 may be made of, for example, a magnetic metal or a magnetic resin material. The first magnetic members 10 may be embedded in the lens holding member 2 by insert molding or the like, or may be stuck to the lens holding member 2.

Next, the positional relation between the first magnetic members 10 and the second magnetic members MG when the shape memory alloy wires SA are not energized will be described with reference to FIG. 8. FIG. 8 shows the positional relation between the first magnetic members 10 attached to the lens holding member 2 and the second magnetic members MG included in the conductive members CM embedded in the base member 18 when the shape memory alloy wires SA are not energized. Specifically, the upper view of FIG. 8 is a perspective view of the first magnetic members 10 and the conductive members CM, and the lower view of FIG. 8 is a top view of the conductive members CM. In the upper view of FIG. 8 and the lower view of FIG. 8, the members other than the first magnetic members 10 and the conductive members CM are omitted for clarity. In the upper view of FIG. 8 and the lower view of FIG. 8, a dot pattern is applied to the second magnetic members MG as a part of the conductive members CM embedded in the base member 18 for clarity. In the lower view of FIG. 8, the outline of the first magnetic members 10 is indicated by a dotted line for clarity.

The second magnetic members MG are members to generate magnetic attraction force with the first magnetic members 10 attached to the lens holding member 2. In the example shown in FIG. 8, the second magnetic members MG include a first metal plate MG1 and a second metal plate MG2. Both the first metal plate MG1 and the second metal plate MG2 are made of magnetic metal. Specifically, the first metal plate MG1 is formed as a part of the ninth conductive member CM9, and the second metal plate MG2 is formed as a part of the tenth conductive member CM10. However, the second magnetic members MG are not required to be made of magnetic metal as long as magnetic attraction force can be generated between each of the second magnetic members MG and the first magnetic members 10 respectively. In this case, the second magnetic members MG may be a magnet. The second magnetic members MG may be formed as members independent of the conductive members CM. In this case, the conductive members CM are preferably formed of a nonmagnetic material such as a nonmagnetic metal. The second magnetic members MG need not be embedded in the base member 18, but may be attached to the base member 18.

When the shape memory alloy wires SA are not energized, as shown in the upper view of FIG. 8 and the lower view of FIG. 8, the first magnetic members 10 are disposed in the housing part HR formed in the protruding parts 2S of the lens holding member 2 so as to be positioned directly above the second magnetic members MG while being separated from the second magnetic MG by members a predetermined distance.

As shown in the lower view of FIG. 8, each of the first magnetic members 10 and the second magnetic members MG are configured such that the area of the upper facing surface CSU of each of the first magnetic members 10 facing the second magnetic members MG is substantially equal to the area of the lower facing surface CSL of each of the second magnetic members MG facing the first magnetic members 10 respectively. This is because when the area of the upper facing surfaces CSU and the area of the lower facing surfaces CSL are significantly different, the positional relation between the first magnetic members 10 and the second magnetic members MG, when the first magnetic members 10 are attracted to the second magnetic members MG due to the magnetic attraction force generated between the first magnetic members 10 and the second magnetic members MG and stop, varies.

Specifically, as shown in the lower view of FIG. 8, the first magnet 10A and the first metal plate MG1 are configured such that the area of the upper facing surface CSU1 of the first magnet 10A facing the first metal plate MG1 is substantially equal to the area of the lower facing surface CSL1 of the first metal plate MG1 facing the first magnet 10A. The second magnet 10B and the second metal plate MG2 are configured such that the area of the upper facing surface CSU2 of the second magnet 10B facing the second metal plate MG2 is substantially equal to the area of the lower facing surface CSL2 of the second metal plate MG2 facing the second magnet 10B.

In the example shown in FIG. 8, each of the first magnetic members 10 has an outline of a substantially rectangular parallelepiped, but may have another outline such as a cylinder or a hexagonal prism. That is, in the example shown in FIG. 8, the upper facing surface CSU has a rectangular outer shape, but may have another outer shape such as a circle or a hexagon. In this case, the lower facing surface CSL preferably has the same outer shape as the upper facing surface CSU.

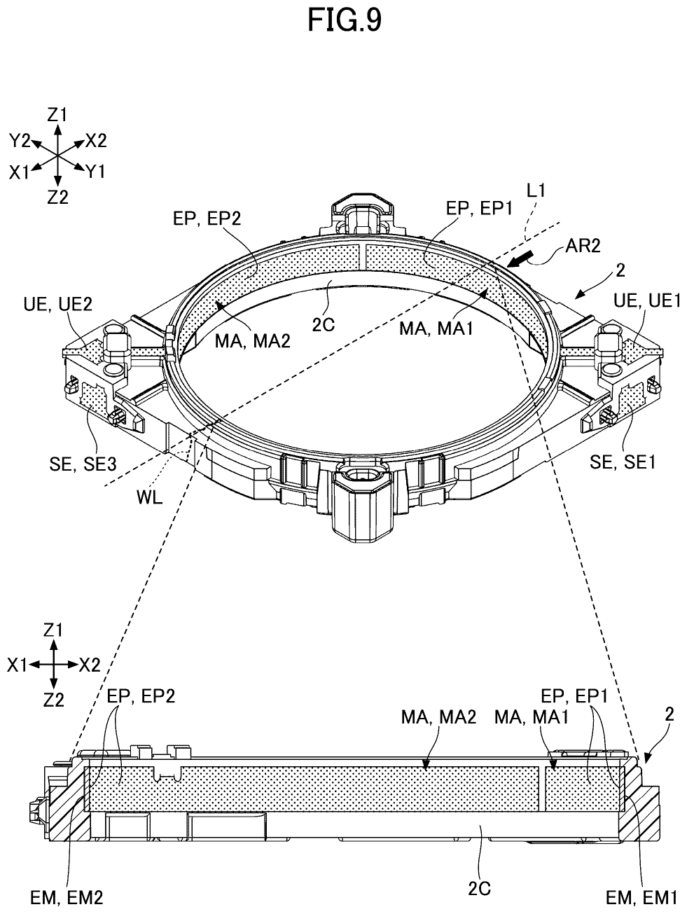

Next, the lens holding member 2 will be described in detail with reference to FIG. 9. FIG. 9 is a drawing showing a structural example of the lens holding member 2 in which the metal adherends MA are embedded. Specifically, the upper view of FIG. 9 is a perspective view of the lens holding member 2 in which the metal adherends MA are embedded. The lower view of FIG. 9 is a sectional view of the lens holding member 2 in which the metal adherends MA are embedded, and shows respective cross sections of the metal adherends MA and the lens holding member 2 in a virtual plane parallel to the XZ plane including the broken line L1 in the upper view of FIG. 9. In the upper view of FIG. 9, a position corresponding to a gate when the lens holding member 2 is injection molded is represented by a black block arrow AR2, and a weld line WL formed during injection molding is represented by a thick dotted line. In FIG. 9, a dot pattern is applied to the metal adherends MA.

In the illustrated example, a second metal adherend MA2 is disposed in a portion of the lens holding member 2 where the weld line WL is formed. That is, the second metal adherend MA2 is disposed so as to cross the confluence interface formed when the molten resins flowing through different paths in the mold merge in injection molding.

With this configuration, the second metal adherend MA2 can reinforce the portion of the lens holding member 2 where the weld line WL is formed, and can prevent the lens holding member 2 from cracking at the portion where the weld line WL is formed.

As shown in the upper view of FIG. 3, the exposed part EP of each of the metal adherends MA is configured to have a substantially semicircular shape in the upper view. This configuration has the effect that the metal adherends MA can be easily manufactured as compared with the case where the exposed part EP has a tubular shape. This is because the metal adherend MA can be formed only by bending one metal plate having a predetermined shape.

As shown in the upper view of FIG. 9, in the lens holding member 2, the position corresponding to the gate (the position indicated by the block arrow AR2) and the position where the weld line WL is formed are opposed to each other across the optical axis OA. The first metal adherend MA1 is disposed on the portion of the lens holding member 2 corresponding to the gate. That is, the metal adherends MA are disposed on both the position corresponding to the gate and the position corresponding to the weld line WL in the lens holding member 2. This configuration can reinforce the lens holding member 2 not only at the weld line WL but also at the portion corresponding to the gate. Therefore, this configuration can prevent the lens holding member 2 from cracking at the portion corresponding to the gate.

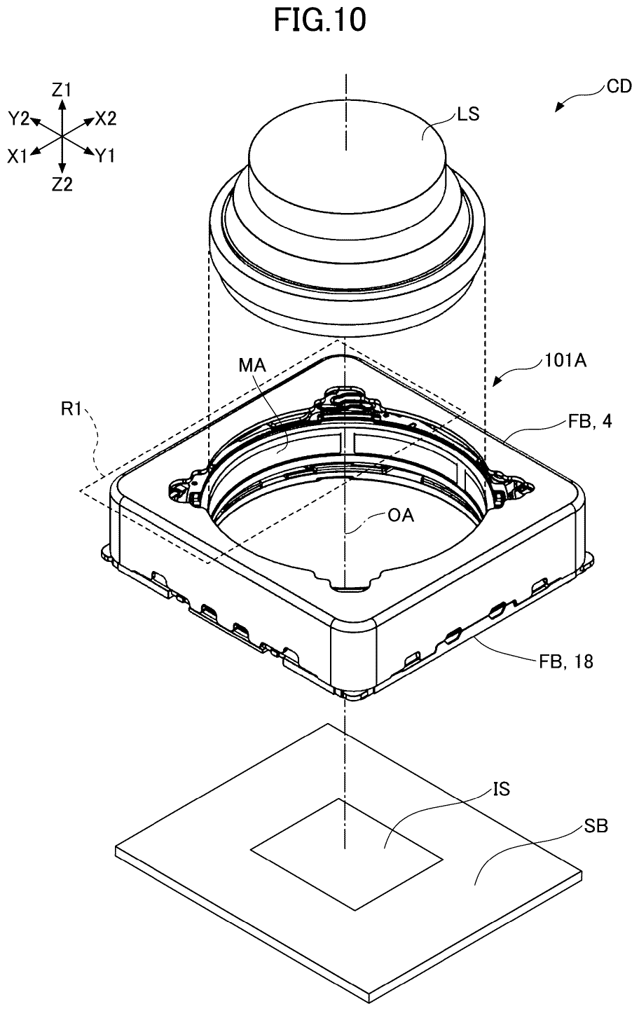

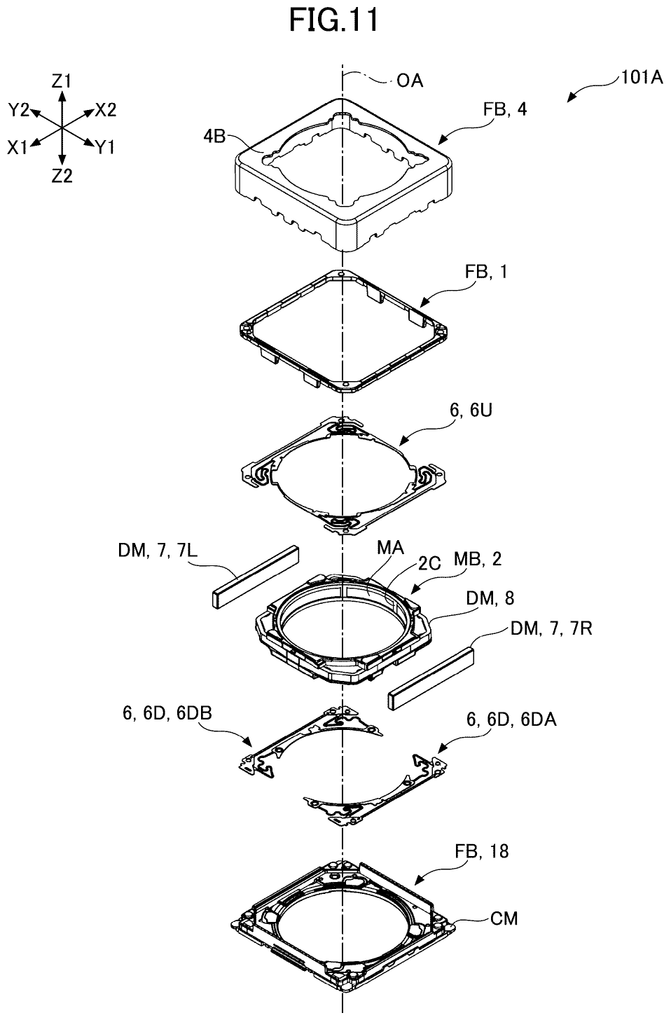

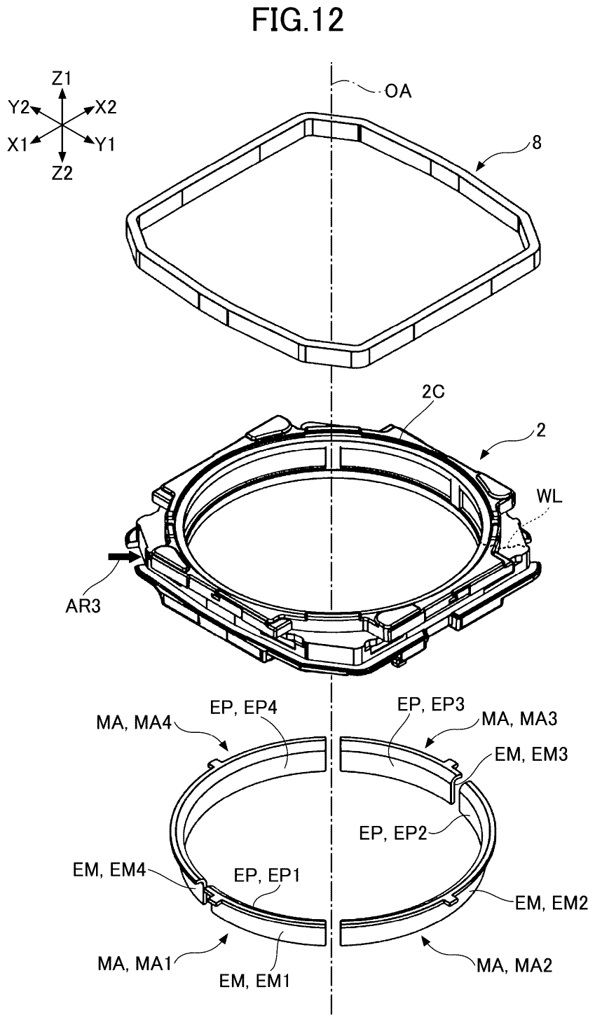

Next, referring to FIGS. 10 to 12, a lens driving apparatus 101A, which is another example of the configuration of the lens driving apparatus 101, will be described. FIG. 10 is a perspective view of the camera module CD including the lens driving apparatus 101A, and corresponds to FIG. 1. FIG. 11 is an exploded perspective view of the lens driving apparatus 101A, and corresponds to FIG. 2. FIG. 12 is a perspective view of the lens holding member 2, the coil 8 wound around the outer peripheral surface of the tubular part 2C of the lens holding member 2, and the metal adherends MA embedded in the lens holding member 2. In FIG. 12, a position corresponding to the gate at the time of injection molding of the lens holding member 2 is represented by a black block arrow AR3, and a weld line WL formed during injection molding is represented by a thick dotted line.

The lens driving apparatus 101A is mainly different from the lens driving apparatus 101 whose actuator DM is composed of a shape memory alloy wires SA, in that the actuator DM is composed of magnets 7 and a coil 8.

Specifically, the lens driving apparatus 101A includes a spacer member 1, a lens holding member 2, a cover member 4, flat springs 6, magnets 7, a coil 8, a base member 18, conductive members CM, and one or more metal adherends MA.

The spacer member 1 is disposed so as to prevent a collision between the lens holding member 2 made of synthetic resin and the cover member 4 made of metal when the lens holding member 2 moves in the Z1 direction. That is, the spacer member 1 is formed of synthetic resin and disposed so as to form a space between the lens holding member 2 and the top plate 4B of the cover member 4. The spacer member 1 is fixed to the cover member 4 by an adhesive. Specifically, the spacer member 1 and the lens holding member 2 are included in a stopper part to restrict excessive movement of the lens holding member 2 in the Z1 direction (upward). In the present embodiment, the lens holding member 2 is configured to contact the spacer member 1 when it moves in the Z1 direction by a predetermined distance. With this configuration, the spacer member 1 can prevent contact between the lens holding member 2 made of synthetic resin and the cover member 4 made of metal, thereby preventing wear of the lens holding member 2 due to such contact. However, if a space can be formed between the lens holding member 2 and the top plate 4B of the cover member 4 by another structure or the like, the spacer member 1 may be omitted.

The flat springs 6 include an upper flat spring 6U and lower flat springs 6D. The lower flat springs 6D include a first lower flat spring 6DA and a second lower flat spring 6 DB. The lower flat spring 6D functions as a conductive path to supply an electric current to the coil 8. The upper flat spring 6U has two outer fixing parts fixed between the lower surface of the spacer member 1 and the upper surface of the magnet 7, a substantially annular inner fixing part fixed to the upper surface of the tubular part 2C of the lens holding member 2, and four elastic arms connecting each of the two outer fixing parts and the inner fixing part. Each of the first lower flat spring 6DA and the second lower flat spring 6 DB has two outer fixing parts fixed to the upper surface of the base member 18, a substantially quarter circular inner fixing part fixed to the lower surface of the tubular part 2C of the lens holding member 2, and two elastic arms connecting each of the two outer fixing parts and the inner fixing part.

The flat springs 6 are joined to both the lens holding member 2 and the base member 18 by caulking or adhesive. With this configuration, the flat springs 6 can support the lens holding member 2 in a state where the lens holding member 2 can be moved in the optical axis direction with respect to the base member 18.

The magnet 7 is a member of the actuator DM. In the illustrated example, the magnets 7 are a bipolar magnetized permanent magnet and include a left magnet 7L and a right magnet 7R.

The coil 8 is a member of the actuator DM. In the illustrated example, the coil 8 is wound around the outer peripheral surface of the tubular part 2C of the lens holding member 2. One end of the coil 8 is electrically connected to the conductive pattern of the substrate SB through the first lower flat spring 6DA and the conductive member CM, and the other end is electrically connected to the conductive pattern of the substrate SB through the second lower flat spring 6 DB and the conductive member CM.

Each of the metal adherends MA is provided in the lens holding member 2 so that a portion thereof is embedded in the lens holding member 2 and the remaining portion thereof is exposed from the lens holding member 2. In the illustrated example, each of the metal adherends MA is partially embedded in the lens holding member 2 by insert molding. As shown in FIG. 12, each of the metal adherends MA has an embedded part EM embedded in the tubular part 2C and an exposed part EP exposed on the inner surface of the tubular part 2C, and the exposed part EP is configured to be a portion bonded and fixed to the lens body LS.

Specifically, as shown in FIG. 12, the metal adherends MA include a first metal adherend MA1 to a fourth metal adherend MA4. The first metal adherend MA1 has a first embedded part EM1 and a first exposed part EP1, the second metal adherend MA2 has a second embedded part EM2 and a second exposed part EP2, the third metal adherend MA3 has a third embedded part EM3 and a third exposed part EP3, and the fourth metal adherend MA4 has a fourth embedded part EM4 and a fourth exposed part EP4. The lens body LS is bonded and fixed to the first exposed part EP1, the second exposed part EP2, the third exposed part EP3, and the fourth exposed part EP4.

The first metal adherend MA1 and the third metal adherend MA3 have the same shape and the same size. Specifically, the first metal adherend MA1 and the third metal adherend MA3 are arcuate members having a central angle of about 60 degrees in the top view, and are configured to be point symmetric in the top view with respect to the optical axis OA. The second metal adherend MA2 and the fourth metal adherend MA4 have the same shape and the same size. Specifically, the second metal adherend MA2 and the fourth metal adherend MA4 are arc-shaped members having a central angle of about 120 degrees in the top view, and are configured to be point-symmetric in the top view with respect to the optical axis OA. Therefore, this configuration can reduce the number of components of the lens driving apparatus 101. The first metal adherend MA1 to the fourth metal adherend MA4 may have the same shape and the same size. For example, the first metal adherend MA1 to the fourth metal adherend MA4 may be configured to be arc-shaped members having a central angle of about 90 degrees in the top view.

In the example shown in FIG. 12, the second metal adherend MA2 is disposed in the portion of the lens holding member 2 where the weld line WL is formed. That is, the second metal adherend MA2 is disposed so as to cross, in the top view, the confluence interface formed when the molten resins flowing through different paths in the mold in injection molding merge.

With this configuration, the second metal adherend MA2 can reinforce the portion of the lens holding member 2 where the weld line WL is formed, and can prevent the lens holding member 2 from cracking at the portion where the weld line WL is formed.

As shown in FIG. 12, the exposed part EP of each of the metal adherends MA is configured to have a substantially arcuate shape in a top view. This configuration has the effect that the metal adherend MA can be easily manufactured as compared with the case where the exposed part EP has a tubular shape. This is because the metal adherend MA can be formed only by bending a single metal plate having a predetermined shape.

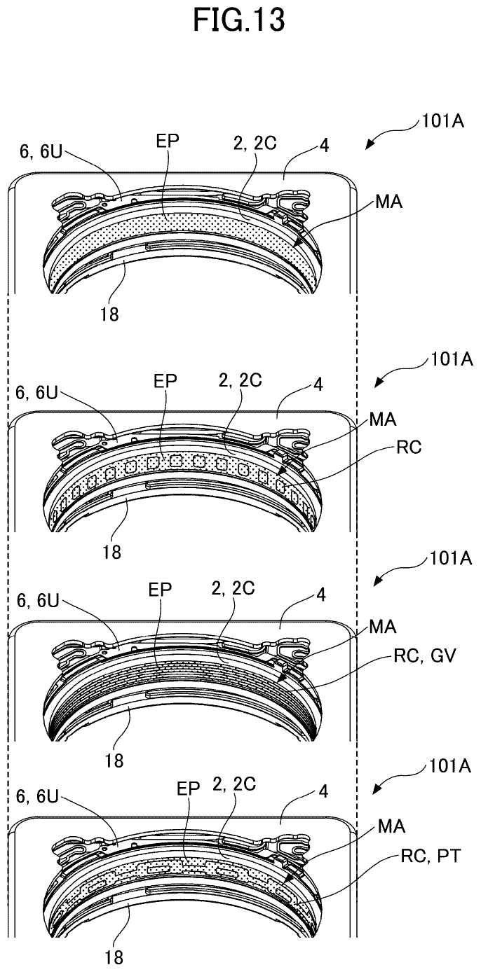

Next, referring to FIG. 13, four other structural examples of the metal adherend MA embedded in the tubular part 2C of the lens holding member 2 of the lens driving apparatus 101A will be described. Each of the four drawings included in FIG. 13 is a perspective view of a part of the lens driving apparatus 101A, and corresponds to a view in which the area R1 enclosed by the broken line in FIG. 10 is viewed obliquely above the Y1 direction.

In the uppermost view in FIG. 13, the metal adherend MA is different from the metal adherends MA shown in FIG. 12 which are composed of four partially tubular members, in that the metal adherend MA is composed of one substantially tubular member.

This configuration has the effect that the adhesive strength between the lens holding member 2 and the lens body LS is increased as compared with the metal adherends MA shown in FIG. 12. This is because the surface area of the exposed part EP is large.

In the second view from the top in FIG. 13, the metal adherend MA is different from the metal adherend MA shown in the uppermost view in FIG. 13 having the surface (inner peripheral surface) without recesses or projections, in that a plurality of recesses RC having substantially rectangular openings are formed on the surface (inner peripheral surface) of the exposed part EP in a side view. Specifically, the plurality of recesses RC are recessed in a direction away from the lens body LS (optical axis OA), have the same shape and the same size, and are disposed at equal intervals along the circumferential direction.

This configuration has the effect of increasing the adhesive strength between the lens holding member 2 and the lens body LS as compared with the metal adherend MA shown in the uppermost view in FIG. 13. This is because the surface area of the exposed part EP is large. This is also because the adhesive enters into the respective recesses RC and hardens them.

In the third view from the top in FIG. 13, the metal adherend MA is different from the metal adherend MA shown in the uppermost view in FIG. 13 having the surface (inner peripheral surface) without recesses or projections, in that the recesses RC formed on the surface (inner peripheral surface) of the exposed part EP include a plurality of grooves GV extending in the circumferential direction. Specifically, the plurality of grooves GV have the same shape and the same size (width), and are disposed at equal intervals along the optical axis direction.

This configuration has the effect of increasing the adhesive strength between the lens holding member 2 and the lens body LS as compared with the metal adherend MA shown in the uppermost drawing in FIG. 13. This is because the surface area of the exposed part EP is large. Also, this is because the adhesive enters the grooves GV and hardens them.

In the lowermost drawing in FIG. 13, the metal adherend MA is different from the metal adherend MA shown in the uppermost drawing in FIG. 13 having the surface (inner peripheral surface) without recesses or projections, in that the metal adherend MA has a pattern PT formed as a recess RC formed on the surface (inner peripheral surface) of the exposed part EP such that a plurality of rectangular annular recesses and a plurality of linear recesses extending in the circumferential direction are disposed alternately in the circumferential direction and the plurality of rectangular annular recesses and the plurality of linear recesses are connected. Specifically, the pattern PT is configured such that each of the plurality of rectangular annular recesses has the same shape and the same size, and each of the plurality of linear recesses has the same shape and the same size. However, the pattern PT may be any other pattern such as a dot-like pattern or a striped pattern.

This configuration has the effect that the adhesive strength between the lens holding member 2 and the lens body LS is increased as compared with the metal adherend MA shown in the uppermost drawing in FIG. 13. This is because the surface area of the exposed part EP is large. This is also because the adhesive penetrates into each of the plurality of rectangular annular recesses and the plurality of linear recesses and hardens them.

In addition, the surface (inner peripheral surface) of the exposed part EP may be subjected to processing for forming unevenness or convexity, such as diamond knurling or knurling.

In the second drawing from the top, the third drawing from the top, and the lowermost drawing of FIG. 13, the metal adherend MA is composed of one substantially tubular member, but may be composed of a combination of two or more partially tubular members. As described above, as shown in FIG. 2 and FIG. 11, each of the lens driving apparatuses 101, 101A according to the embodiment of the present disclosure includes the fixed member FB, the lens holding member 2 having the tubular part 2C capable of holding the lens body LS adhered thereto with an adhesive, and an actuator DM configured to move the lens holding member 2 with respect to the fixed member FB. The lens holding member 2 is formed of synthetic resin in which one or more metal adherends MA are embedded. As shown in FIG. 3 and FIG. 12, the metal adherends each have both the embedded part embedded in the tubular part and the exposed part exposed on the inner surface of the tubular part, and are configured such that the exposed part serves as the portion bonded and fixed to the lens body, and wherein at least one of the metal adherends is disposed at the position corresponding to the weld line formed when the lens holding member is molded.

This configuration has the effect that the adhesive strength between the lens body LS and the lens holding member 2 can be increased as compared with the case where the inner surface of the tubular part 2C of the lens holding member 2 to which the lens body LS comes into contact is formed of synthetic resin. This is because the metal adherends MA are exposed to the inner surface of the tubular part 2C of the lens holding member 2. That is, the adhesive strength between the lens body LS and the metal (metal adherend MA) is greater than the adhesive strength between the lens body LS and the synthetic resin material (lens holding member 2). This configuration also has the effect that the occurrence of a problem such as the lens holding member 2 cracking from the weld line WL when a strong impact such as a drop is applied can be suppressed. This is because at least one of the metal adherends MA is disposed at a position corresponding to the weld line WL of the lens holding member 2.

The metal adherend MA disposed at a position corresponding to the weld line WL is desirably disposed so as to be exposed to the surface of the tubular part 2C. In the example shown in FIG. 9, the second metal adherend MA2 disposed at the position corresponding to the weld line WL is disposed such that the second exposed part EP2 is exposed to the inner surface of the tubular part 2C as shown in the lower drawing of FIG. 9.

This configuration has the effect that the adhesion between the two portions formed of synthetic resin and positioned across the weld line WL can be improved, as compared with the configuration in which the metal adherend MA disposed at the position corresponding to the weld line WL is not exposed to the surface of the tubular part 2C. This is because, in the configuration in which the metal adherend MA disposed at the position corresponding to the weld line WL is not exposed to the surface of the tubular part 2C, that is, in the configuration in which the metal adherend MA is completely embedded in the tubular part 2C, the thickness of each of these two portions (the width in the radial direction of the circle about the optical axis OA) is divided into a portion positioned radially at an inner position relative to the metal adherend MA and a portion positioned radially at an outer position relative to the metal adherend MA and becomes small. In other words, in the configuration in which the metal adherend MA disposed at the position corresponding to the weld line WL is exposed to the inner surface of the tubular part 2C, these two portions are positioned only radially at an outer position relative to the metal adherend MA and are not divided by the metal adherend MA, so that the thickness of each of the two portions can be increased.

The metal adherends MA may also have a first metal adherend MA1 and a second metal adherend MA2 separated from each other and disposed at different positions in the circumferential direction of the tubular part 2C, as shown in FIG. 3. In this case, each of the first metal adherend MA1 and the second metal adherend MA2 may have an embedded part EM and an exposed part EP. The first metal adherend MA1 or the second metal adherend MA2 may be disposed at a position corresponding to the weld line WL. In the example shown in FIG. 3, the first metal adherend MA1 has a first embedded part EM1 and a first exposed part EP1, and the second metal adherend MA2 has a second embedded part EM2 and a second exposed part EP2. The second metal adherend MA2 is disposed at a position corresponding to the weld line WL.

This configuration has the effect that the productivity of the metal adherend MA can be improved, and the productivity of the lens driving apparatus 101 can be improved, as compared with the case where the metal adherend MA is formed in an annular (tubular) shape by one metal plate. This is because, while drawing is required when the metal adherend MA is formed in an annular (tubular) shape by one metal plate, when the metal adherend MA is formed by two or more metal plates, the metal adherend MA having a desired shape can be obtained only by bending the metal plate. That is, when the metal adherend MA is formed by two or more metal plates, the number of drawing operations can be reduced, or the metal adherend MA can be manufactured without drawing. Even when the metal adherend MA is formed by two or more metal plates, for example, as shown in FIG. 9, one of the plurality of metal adherends MA (the second metal adherend MA2) is disposed at a position corresponding to the weld line WL. Therefore, when a strong impact such as a drop is applied, the lens holding member 2 does not easily break from the weld line WL.

Further, the exposed parts EP of the first metal adherend MA1 and the second metal adherend MA2 may extend in the circumferential direction of the tubular part 2C. For example, each of the first exposed part EP1 of the first metal adherend MA1 and the second exposed part EP2 of the second metal adherend MA2 may be formed in an arc shape having a center angle of about 180 degrees in a top view as shown in FIG. 3.

This configuration has the effect that the adhesive strength between the lens body LS and the metal adherends MA can be increased. This is because the longer the exposed part EP extends in the circumferential direction, the larger the contact area between the adhesive disposed between the lens body LS and the metal adherends MA and the metal adherends MA.

Further, as shown in the second, third, and fourth views from the top in FIG. 13, the exposed part EP may have a plurality of recesses RC extending in the circumferential direction of the tubular part 2C and capable of containing the adhesive. In this case, the recesses RC may be recessed in the direction away from the lens body LS (optical axis OA).

This configuration has the effect that the adhesive strength between the lens body LS and the metal adherend MA can be enhanced as compared with the configuration in which the recesses RC are not provided as shown in the uppermost view in FIG. 13. This is because the contact area between the adhesive disposed between the lens body LS and the metal adherend MA, and the metal adherend MA is increased by the amount of the lateral walls of the recesses RC. This is also because the hardened adhesive engages with the recesses RC having an undercut shape and becomes difficult to peel off. The undercut shape means a shape that cannot be released in the opening and closing direction of the mold when the injection-molded product is taken out of the mold.

Further, as shown in the third drawing from the top in FIG. 13, the plurality of recesses RC may be a plurality of grooves GV extending in the circumferential direction of the tubular part 2C.

This constitution has the effect that the adhesive strength between the lens body LS and the metal adherend MA can be increased as compared with the constitution in which the recesses RC are not provided as shown in the uppermost drawing in FIG. 13. This is because the contact area between the metal adherend MA and the adhesive disposed between the lens body LS and the metal adherend MA increases by the amount of the lateral walls of the grooves GV. This is also because the hardened adhesive engages with the grooves GV having an undercut shape and becomes difficult to peel off.

Further, as shown in FIG. 2, the actuator DM may be formed of shape memory alloy wires SA provided between the movable member MB including the lens holding member 2 and the fixed member FB. In this case, as shown in FIG. 5, one end of each of the shape memory alloy wires SA may be fixed to the movable metal member 5M respectively provided on the movable member MB (lens holding member 2), and each of the other end of the shape memory alloy wires SA may be fixed to the fixed metal member 5F respectively provided on the fixed member FB (base member 18). Further, as shown in FIG. 3, the metal adherends MA may further include an outer exposed part SE exposed on the outer surface of the lens holding member 2. The movable metal members 5M may be fixed to the outer exposed part SE.

This configuration has the effect that each of the movable metal members 5M to fix one end of the shape memory alloy wire SA respectively can be attached to the lens holding member 2 using the metal adherends MA embedded in the lens holding member 2.

Each of the movable metal members 5M and the outer exposed parts SE may be welded respectively.

This configuration has the effect that each of the movable metal members 5M can be attached to the lens holding member 2 respectively with high productivity as compared with the case where each of the movable metal members 5M and the outer exposed parts SE are joined respectively using an adhesive.

The preferred embodiment of the present invention has been described in detail. Further, the present invention is not limited to these embodiments, but various variations and modifications may be made without departing from the scope of the present invention.

What is claimed is:

1. A lens driving apparatus comprising:
a fixed member;
a lens holding member having a tubular part capable of holding a lens body adhered thereto with an adhesive; and
an actuator configured to move the lens holding member with respect to the fixed member,
wherein the lens holding member is formed of synthetic resin in which one or more metal adherends are embedded,
wherein the metal adherends each have both an embedded part embedded in the tubular part and an exposed part exposed on an inner surface of the tubular part, and are configured such that the exposed part serves as a portion bonded and fixed to the lens body, and
wherein at least one of the metal adherends is disposed at a position corresponding to a weld line formed when the lens holding member is molded.

2. The lens driving apparatus according to claim 1, wherein the at least one of the metal adherends disposed at the position corresponding to the weld line is exposed on a surface of the tubular part.

3. The lens driving apparatus according to claim 1, wherein the metal adherends include a first metal adherend and a second metal adherend separated from each other and disposed at different positions in a circumferential direction of the tubular part,
wherein each of the first metal adherend and the second metal adherend has the embedded part and the exposed part, and
wherein the first metal adherend is disposed at the position corresponding to the weld line.

4. The lens driving apparatus according to claim 3, wherein the exposed part of each of the first metal adherend and the second metal adherend extends in the circumferential direction of the tubular part.

5. The lens driving apparatus according to claim 1, wherein the exposed part extends in a circumferential direction of the tubular part, and has a plurality of recesses capable of containing the adhesive.

6. The lens driving apparatus according to claim 5, wherein the plurality of recesses are a plurality of grooves extending in the circumferential direction of the tubular part.

7. The lens driving apparatus according to claim 1,
wherein the actuator includes one or more shape memory alloy wires provided between a movable member and the fixed member, the movable member including the lens holding member,
wherein one end of each of the shape memory alloy wires is fixed to a movable metal member provided on the movable member,
wherein another end of each of the shape memory alloy wires is fixed to a fixed metal member provided on the fixed member,
wherein the metal adherends further include an outer exposed part exposed to an outer surface of the lens holding member, and
wherein the movable metal member is fixed to the outer exposed part.

8. The lens driving apparatus according to claim 7, wherein the movable metal member and the outer exposed part are welded to each other.

9. A camera module comprising:
the lens driving apparatus of claim 1;
the lens body fixed to the lens holding member by the adhesive; and
an imaging sensor facing the lens body.
